(19) United States
(12) Patent Application Publication
(10) Pub. No.: US 2018/0033133 A1
(43) Pub. Date: Feb. 1, 2018

(54) Surface Analysis Systems and Methods of Identifying Visible Surfaces Using the Same

(71) Applicant: Toyota Motor Engineering & Manufacturing North America, Inc., Erlanger, KY (US)

(72) Inventor: Aaron Burton, Fort Wright, KY (US)

(73) Assignee: Toyota Motor Engineering & Manufacturing North America, Inc., Erlanger, KY (US)

(21) Appl. No.: 15/221,012

(22) Filed: Jul. 27, 2016

(51) Int. Cl. G06T 7/00; H04N 5/30; G06K 9/00; H04W 4/00

(52) U.S. Cl. CPC G06T 7/004; H04W 4/008; H04N 5/30; G06K 9/00335; G06T 2207/30268

(57) ABSTRACT

A surface analysis system includes a sensor for generating data regarding a location of an object, one or more processors, and one or more memory modules. The surface analysis system measures a plurality of head locations of a head of an observer within an observation environment during an observation period using the sensor. The one or more surfaces are positioned in the observation environment. Further, the surface analysis system identifies one or more visible surfaces of the one or more surfaces positioned in the observation environment based on the plurality of head locations measured during the observation period. Moreover, the one or more visible surfaces include at least one of the one or more surfaces positioned in the observation environment and the one or more visible surfaces are positioned unobstructed from at least one head location of the observer measured during the observation period.

### TECHNICAL FIELD

Embodiments described herein generally relate to surface analysis systems and, more specifically, methods and systems for identifying one or more visible surfaces positioned in an observation environment, such as a vehicle.

### BACKGROUND

When designing a product, it may be useful for a designer to know which surfaces of the product, for example, a vehicle, will be visible to a consumer, such that the aesthetic design of these surfaces may be prioritized.

Accordingly, a need exists for systems and methods for identifying one or more visible surfaces of a product, for example, a vehicle, and determining the likelihood of observation of each of these visible surfaces.

### SUMMARY

In one embodiment, a surface analysis system includes a sensor for generating data regarding a location of an object, one or more processors communicatively coupled to the sensor, one or more memory modules communicatively coupled to the one or more processors, and machine readable instructions stored in the one or more memory modules that cause the surface analysis system to perform at least the following when executed by the one or more processors: measure a plurality of head locations of a head of an observer within an observation environment during an observation period using the sensor. The one or more surfaces are positioned in the observation environment. Further, the machine readable instructions cause the surface analysis system to identify one or more visible surfaces of the one or more surfaces positioned in the observation environment based on the plurality of head locations measured during the observation period. Moreover, the one or more visible surfaces include at least one of the one or more surfaces positioned in the observation environment and the one or more visible surfaces are positioned unobstructed from at least one head location of the observer measured during the observation period.

In another embodiment, a method of identifying visible surfaces within an observation environment includes measuring, using a sensor configured to generate data regarding a location of an object, a plurality of head locations of a head of an observer within an observation environment during an observation period. The one or more surfaces are positioned in the observation environment. The method further includes identifying one or more visible surfaces of the one or more surfaces positioned in the observation environment based on the plurality of head locations measured during the observation period. Moreover, the one or more visible surfaces include at least one of the one or more surfaces positioned in the observation environment and the one or more visible surfaces are positioned unobstructed from at least one head location of the observer measured during the observation period.

In yet another embodiment a surface analysis system includes a sensor for generating data regarding an orientation of an object, one or more processors communicatively coupled to the sensor, one or more memory modules communicatively coupled to the one or more processors, and machine readable instructions stored in the one or more memory modules that cause the surface analysis system to perform at least the following when executed by the one or more processors: measure a plurality of head orientations of a head of an observer within an observation environment during an observation period using the sensor. Each head orientation of the plurality of head orientations corresponds with a field of view extending from the head of the observer into the observation environment and one or more surfaces are positioned in the observation environment. Further, the machine readable instructions cause the surface analysis system to identify one or more visible surfaces of the one or more surfaces positioned in the observation environment based on the plurality of head orientations measured during the observation period. The one or more visible surfaces include at least one of the one or more surfaces positioned in the observation environment and the one or more visible surfaces are within a field of view corresponding with at least one head orientation of the observer measured during the observation period.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an surface analysis system, according to one or more embodiments shown and described herein;

FIG. 2 depicts an example observation environment comprising a vehicle, according to one or more embodiments shown and described herein;

FIG. 3A schematically depicts a top view of an observer located in an example observation environment including one or more surfaces, according to one or more embodiments shown and described herein;

FIG. 3B schematically depicts a side view of the observer located in the example observation environment of FIG. 3A, according to one or more embodiments shown and described herein;

FIG. 4A schematically depicts a top view of a head location probability cloud corresponding to a location of an observer's head in an observation environment, according to one or more embodiments shown and described herein;

FIG. 4B schematically depicts a side view of the head location probability cloud corresponding to the location of the observer's head in the observation environment of FIG. 4A, according to one or more embodiments shown and described herein;

FIG. 5A schematically depicts a top view of a visibility polygon corresponding to a location of an observer's head in an observation environment, according to one or more embodiments shown and described herein;

FIG. 5B schematically depicts a side view of the visibility polygon corresponding to the location of the observer's head in the observation environment of FIG. 5A, according to one or more embodiments shown and described herein;

FIG. 6A schematically depicts a top view of a surface observation probability map corresponding to one or more surfaces of an example observation environment, according to one or more embodiments shown and described herein;

FIG. 6B schematically depicts a side view of the surface observation probability map corresponding to the one or more surfaces of the example observation environment of FIG. 6A, according to one or more embodiments shown and described herein;

FIG. 7A schematically depicts a top view of an observer located in another example observation environment including one or more surfaces, according to one or more embodiments shown and described herein;

FIG. 7B schematically depicts a side view of the observer located in the example observation environment of FIG. 7A, according to one or more embodiments shown and described herein; and

FIG. 8 depicts a flow diagram of a method of identifying one or more visible surfaces in an observation environment using the surface analysis system, according to one or more embodiments shown and described herein.

### DETAILED DESCRIPTION

The embodiments disclosed herein include a surface analysis system for identifying visible surfaces of parts positioned in an observation environment, such as visible surfaces of parts of a vehicle, by observing an observer positioned in the observation environment. The surface analysis system may measure a plurality of head locations of the observer during one or more observation periods using one or more sensors. Further, the surface analysis system may identify the one or more visible surface by determining which surfaces are positioned unobstructed from at least one of these head locations. The one or more sensors may be image sensors, proximity sensors, and/or motion capture sensors and may interact with one or more motion trackers located on the observer to determine the head location of the head of the observer. In some embodiments, the surface analysis system may also determine the surface observation probability of each of the surfaces positioned in the observation environment. By identifying visible surfaces and surface observation probabilities, the surface analysis system allows a designer and manufacturer of the parts to prioritize and improve the design, manufacture, and assembly of these highly visible parts and part surfaces. The surface analysis system and will now be described in more detail herein with specific reference to the corresponding drawings.

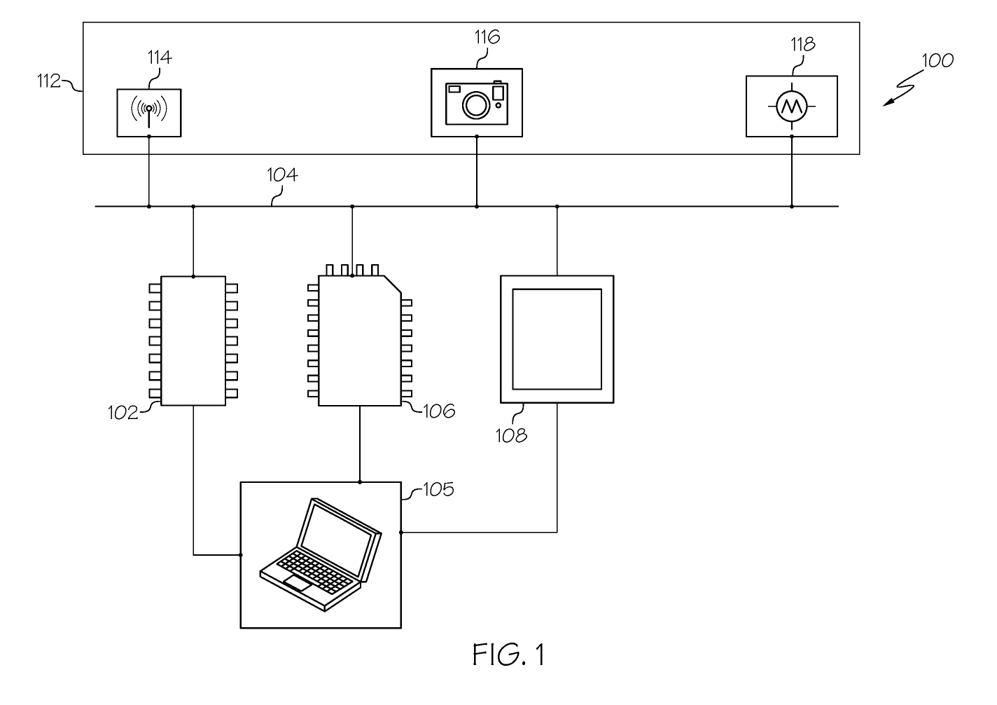

Referring now to FIG. 1, an embodiment of a surface analysis system 100 is schematically depicted. The surface analysis system 100 includes one or more processors 102. Each of the one or more processors 102 may be any device capable of executing machine readable instructions. Accordingly, each of the one or more processors 102 may be a controller, an integrated circuit, a microchip, a computer, or any other computing device. For example, the one or more processors 102 may be processors of a computing device 105. The one or more processors 102 are coupled to a communication path 104 that provides signal interconnectivity between various components of the surface analysis system 100. Accordingly, the communication path 104 may communicatively couple any number of processors 102 with one another, and allow the components coupled to the communication path 104 to operate in a distributed computing environment. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth, and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors (e.g., sensors 112 described herein), input devices, output devices, and communication devices. Accordingly, the communication path 104 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Moreover, the surface analysis system 100 includes one or more memory modules 106 coupled to the communication path 104. The memory modules 106 may be one or more memory modules of the computing device 105. Further, the one or more memory modules 106 may comprise RAM, ROM, flash memories, hard drives, or any device capable of storing machine readable instructions such that the machine readable instructions can be accessed by the one or more processors 102. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 106. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

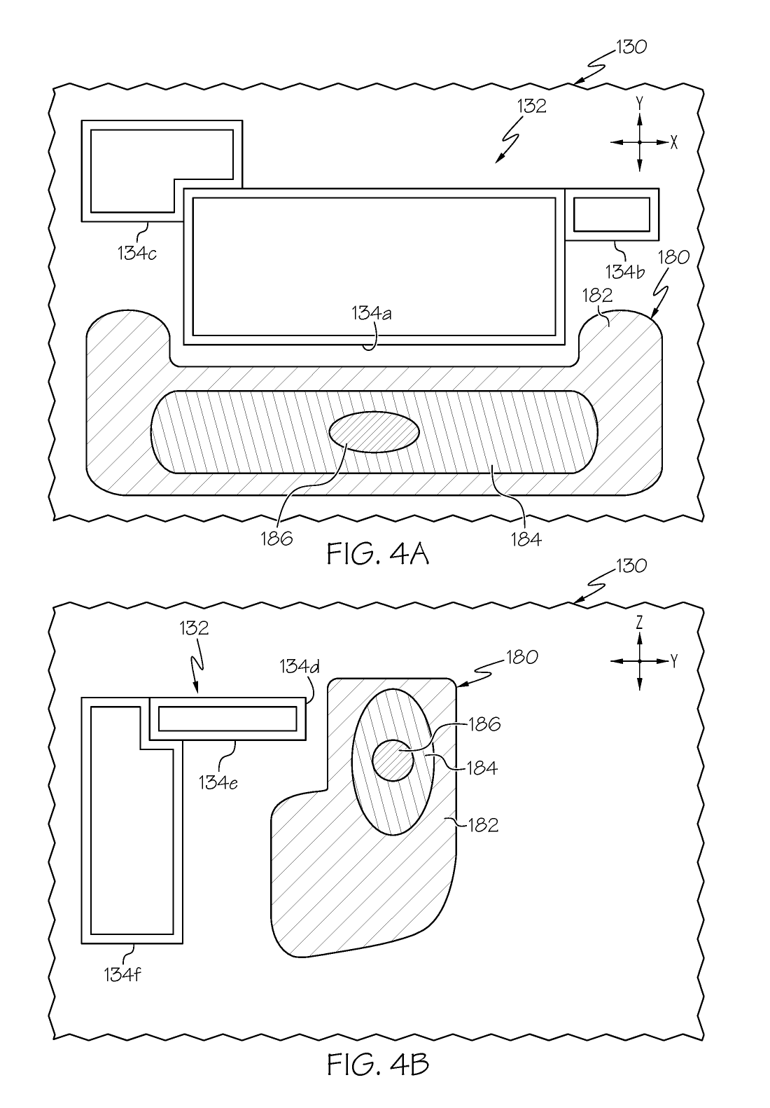

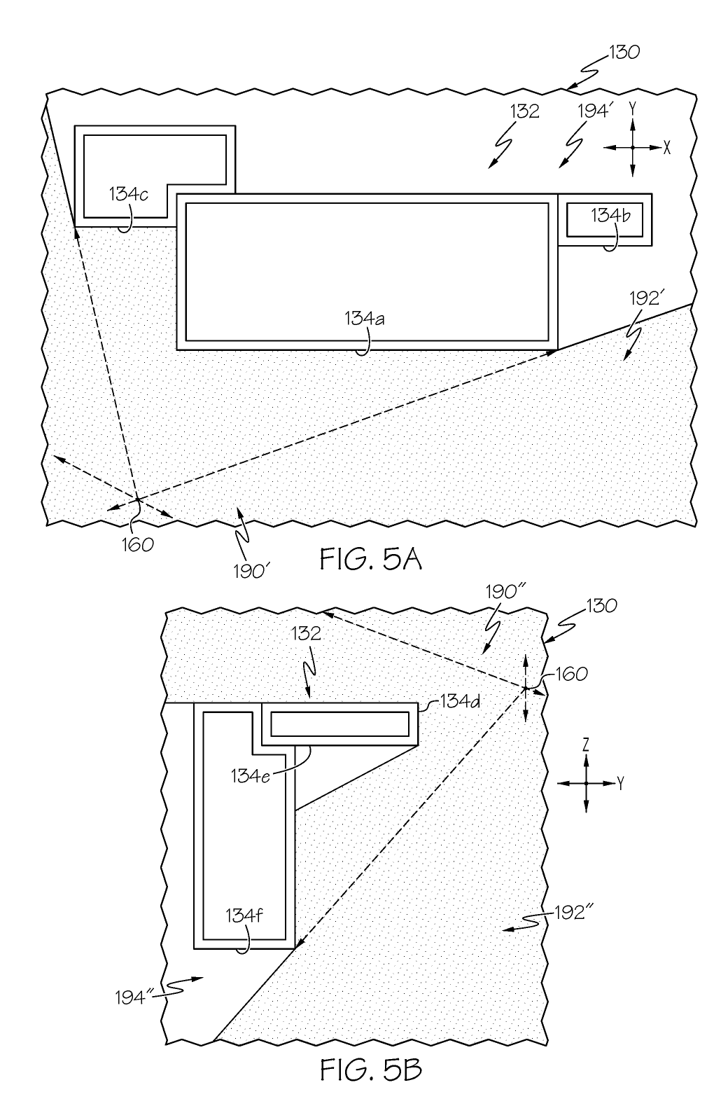

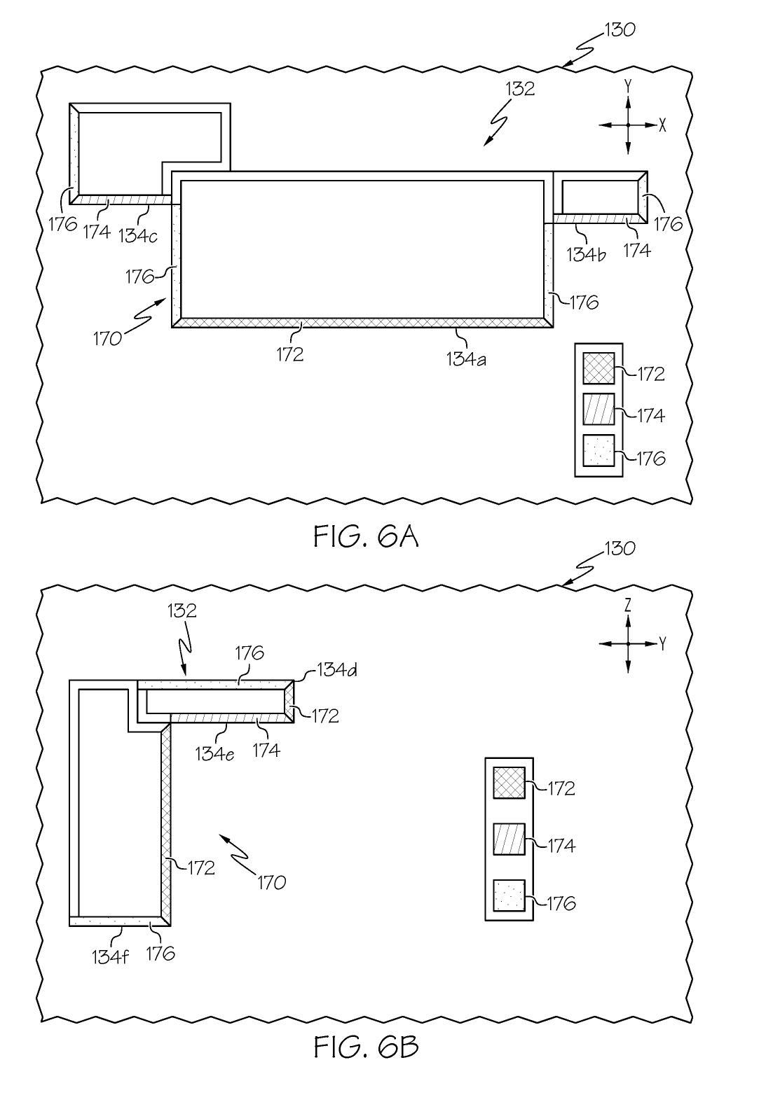

Referring still to FIG. 1, the surface analysis system 100 comprises a display 108 for providing visual output such as, visual depictions of sensor data, probability clouds (FIGS. 4A and 4B), visibility polygons (FIGS. 5A and 5B), surface observation probability maps (FIGS. 6A and 6B), or the like. The display 108 is coupled to the communication path 104. Accordingly, the communication path 104 communicatively couples the display 108 to other components of the surface analysis system 100. The display 108 may include any medium capable of transmitting an optical output such as, for example, a cathode ray tube, light emitting diodes, a liquid crystal display, a plasma display, or the like. In some embodiments, the display 108 may comprise a display of the computing device 105. Moreover, the display 108 may be a touchscreen that, in addition to providing optical information, detects the presence and location of a tactile input upon a surface of or adjacent to the display. Accordingly, each display may receive mechanical input directly upon the optical output provided by the display.

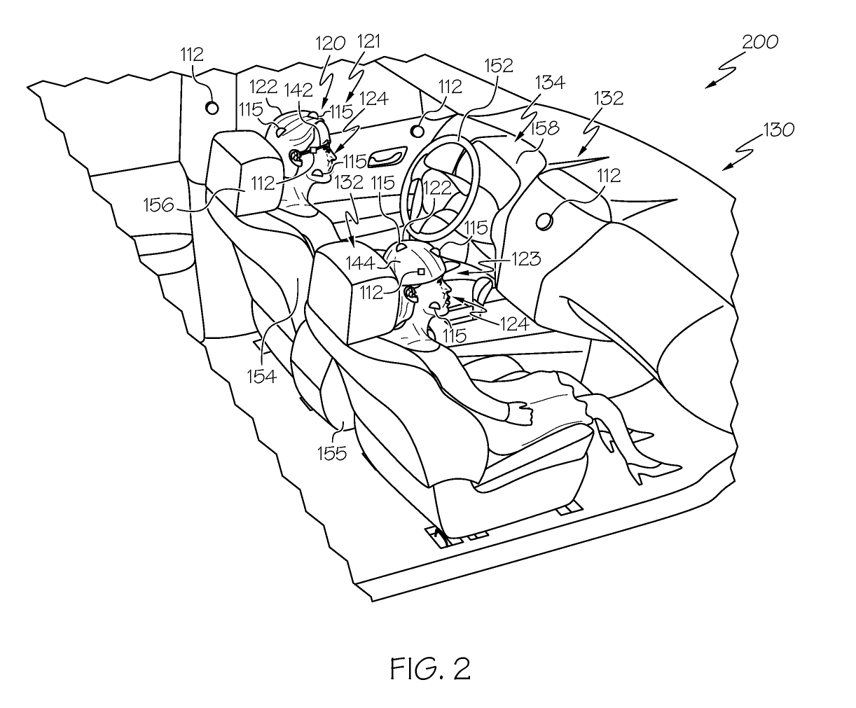

Referring now to FIGS. 1 and 2, the surface analysis system 100 further comprises one or more sensors 112, for example, one or more of an image sensor 114, a proximity sensor 116, and/or a motion capture sensor 118. In operation, each of the one or more sensors 112 may be configured to generate data regarding a location (e.g., a spatial location) and, in some embodiments, an orientation of an object, for example, a head 122 of an observer 120 positioned in an observation environment 130 (FIGS. 2A, 2B, 6A, and 6B). In some embodiments, the surface analysis system 100 may further comprise one or more tracking markers 115 configured to be worn by the observer 120. In operation, the one or more tracking markers 115 may interact with the one or more sensors 112 to generate data regarding a location and/or orientation of the observer 120 (e.g., the head 122 of the observer 120).

As depicted in FIG. 1, the image sensor 114 is coupled to the communication path 104 such that the communication path 104 communicatively couples the image sensor 114 to other components of the surface analysis system 100. The image sensor 114 may comprise any imaging device configured to capture image data of the observation environment 130 and the observer 120 positioned in the observation environment 130. The image data may digitally represent at least a portion of the observation environment 130 or the observer 120, for example, the head 122 of the observer 120. In operation, the image sensor 114 may interact with the one or more tracking markers 115 when the one or more tracking markers 115 are worn by the observer 120, to determine the location of the observer 120 (e.g., the spatial location of the head 122 of the observer 120) and, in some embodiments, the orientation of the head 122 of the observer 120 (e.g., a pointing direction of a face 124 of the observer 120).

The image sensor 114 may comprise any sensor operable to capture image data, such as, without limitation, a charged-coupled device image sensors or complementary metal-oxide-semiconductor sensors capable of detecting optical radiation having wavelengths in the visual spectrum, for example. The image sensor 114 may be configured to detect optical radiation in wavelengths outside of the visual spectrum, such as wavelengths within the infrared spectrum. In some embodiments, two or more image sensors 114 are provided to generate stereo image data capable of capturing depth information. Moreover, in some embodiments, the image sensor 114 may comprise a camera, which may be any device having an array of sensing devices (e.g., pixels) capable of detecting radiation in an ultraviolet wavelength band, a visible light wavelength band, or an infrared wavelength band.

Still referring to FIG. 1, the proximity sensor 116 is communicatively coupled to the communication path 104 such that the communication path 104 communicatively couples the proximity sensor 116 to other components of the surface analysis system 100. The proximity sensor 116 may be any device capable of outputting a proximity signal indicative of a proximity of an object to the proximity sensor 116. In some embodiments, the proximity sensor 116 may include a laser scanner, a capacitive displacement sensor, a Doppler effect sensor, an eddy-current sensor, an ultrasonic sensor, a magnetic sensor, an optical sensor, a radar sensor, a sonar sensor, or the like. Some embodiments may not include the proximity sensor 116. In operation, the proximity signal may be used to determine the location of the observer 120 and in some embodiments, the orientation of the observer 120. For example, the proximity sensor 116 may interact with the one or more tracking markers 115 when the one or more tracking markers 115 are worn by the observer 120, to determine the location of the observer 120 (e.g., the spatial location of the head 122 of the observer 120) and, in some embodiments, the orientation of the head 122 of the observer 120 (e.g., the pointing direction of the face 124 of the observer 120).

Further, the motion capture sensor 118 is communicatively coupled to the communication path 104 such that the communication path 104 communicatively couples the motion capture sensor 118 to other components of the surface analysis system 100. The motion capture sensor 118 comprises one or more sensors that are wearable by the observer 120 and are configured to measure the spatial location and/or the orientation of the observer 120. For example, the motion capture sensor 118 may comprise an inertial sensor having an inertial measurement unit (IMU). For example, the IMU may include a gyroscope, a magnetometer, and an accelerometer. Further, the motion capture sensor 118 may comprise one or more RF sensors configured to transmit an RF signal regarding the spatial location and/or orientation of the head 122 of the observer 120. Moreover, the motion capture sensor 118 may comprise one or more magnetic sensors configured to transmit a magnetic signal regarding the spatial location and/or orientation of the head 122 of the observer 120.

Referring now to FIG. 2, the one or more sensors 112 and/or one or more tracking markers 115 may be coupled to a wearable device 140 configured to be worn by the observer 120, for example, eyeglasses 142, headwear 144, or any other wearable device configured to monitor the position and/or orientation of the head 122 of the observer 120. Further, the one or more tracking markers 115 may be directly coupled to the observer 120, for example, using an adhesive or a fastening mechanism. As a non-limiting example, the one or more sensors 112, for example, image sensors 114 and/or proximity sensors 116 may be positioned in the observation environment 130 apart from the observer 120 and the one or more tracking markers 115 may be positioned on the head 122 of the observer 120 using the wearable device 140 or by directly coupling the one or more tracking markers 115 to the head 122 of the observer 120. As another non-limiting example, the motion capture sensors 118 may be coupled to the observer 120 and/or the wearable device 140 and may measure the location and/or orientation of the head of the observer 120 without use of additional sensors 112. In operation, the sensors 112 may monitor the observer 120, for example, by monitoring the tracking markers 115 and may generate sensor data regarding the location and or orientation of the head of the observer 120.

Referring still to FIG. 2, an embodiment of the observation environment 130 comprising a vehicle 150 is depicted. The observation environment 130 (e.g., the vehicle 150) includes one or more component parts 132 each comprising one or more surfaces 134. For example, the one or more component parts 132 may comprise one or more interior vehicle parts such as a seat 154, a dashboard 158, a steering wheel 152, a central storage console 155, one or more interior panels, a vehicle floor, or the like. Further, the one or more component parts 132 may comprise one or more exterior vehicle parts, for example, one or more doors, a hood, a wheel, a bumper, one or more exterior vehicle panels, or the like. Moreover, the one or more surfaces 134 may comprise surfaces of any vehicle part, for example, the above described vehicle parts. While the observation environment 130 is described herein as including the vehicle 150 and the one or more surfaces 134 are described as vehicle part surfaces, it should be understood that the surface analysis system 100 may analyze surfaces in any observation environment 130.

As depicted in FIG. 2, the observer 120 may be positioned in the observation environment 130, for example, in the vehicle 150. In the embodiment depicted in FIG. 2, the observer 120 may be a driver 121 of the vehicle 150 or a passenger 123 in the vehicle 150. In operation, the one or more sensors 112 monitor the observer 120 during one or more observation periods. An individual observation period may comprise any period of time. As a non-limiting example, the observation period may comprise between about 1 minute and about 120 minutes, for example 5 minutes, 15 minutes, 30 minutes, 60 minutes, 90 minutes, or the like. Further, when the observation environment 130 comprises the vehicle 150, individual observation periods may comprise a period of time corresponding with operation of the vehicle 150 and the one or more sensors 112 may monitor the observer 120 while the observer 120 (e.g., the driver 121) is driving the vehicle 150 or while the observer 120 is riding as the passenger 123 of the vehicle 150.

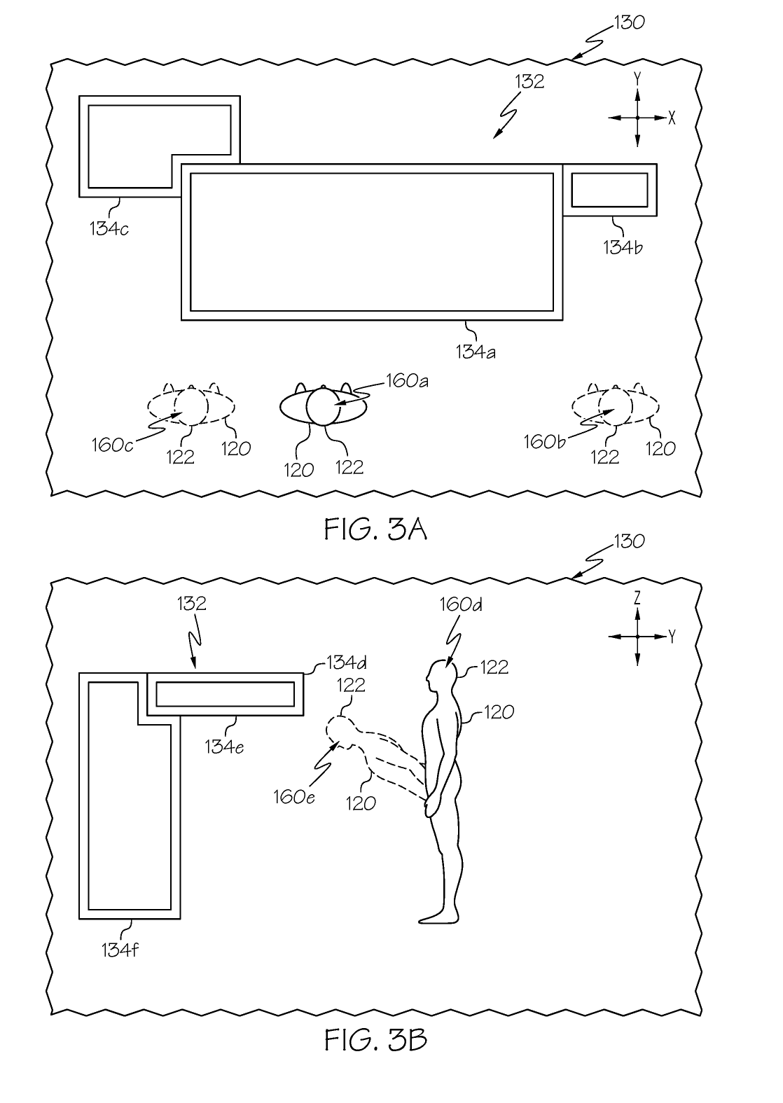

During the observation period, the one or more sensors 112 may measure one or more head locations 160 (FIGS. 3A and 3B) of the head 122 of the observer 120 and, in some embodiments, measure one or more head orientations 162 (FIGS. 4A and 4B) of the head 122 of the observer 120. The one or more sensors 112 may output sensor data to the one or more processors 102 of the surface analysis system 100, for example, head location data and/or head orientation data. Using the head location data and/or the head orientation data generated during the observation period, the one or more processors 102 of the surface analysis system 100 may identify which of the one or more surfaces 134 are visible to the observer 120 and determine the probability that an individual surface of the one or more surfaces 134 is visible from any one individual head location 160 and/or any one individual head orientation 162 of the observer 120. Moreover, the surfaces 134 described in the embodiments and examples herein may be full surfaces, or segments (e.g., portions) of full surfaces. Thus, it should be understood that the surfaces 134 may refer to any surface segment of the one or more component parts 132. Identifying the surfaces that are visible from at least one head location 160 or head orientation 162 and determining the likelihood of visibility of each surface 134 provides information for a manufacturer of the one or more component parts 132 (e.g., a manufacturer of the vehicle 150) regarding the likelihood that a user will see the component parts 132. This information allows the manufacturer to prioritize manufacturing and installation resources to parts and surfaces that are highly visible, improving the visible quality of these parts.

Referring now to FIGS. 3A-7B, example observation environments 130 are depicted to help illustrate the operation of the surface analysis system 100. FIG. 3A schematically depicts a top view of the observer 120 and the plurality of component parts 132 each comprising at least one surface 134, for example, a first surface 134a, a second surface 134b, and a third surface 134c. Further, FIG. 3A depicts multiple head locations 160 of the observer 120 along an X-Y coordinate plane, for example, a first head location 160a, a second head location 160b, and a third head location 160c. FIG. 3B schematically depicts a side view of the observer 120 and the plurality of component parts 132 each comprising at least one surface 134, for example, a fourth surface 134d, a fifth surface 134e, and a sixth surface 134f. Further, FIG. 3B depicts multiple head locations along a Y-Z coordinate plane, for example, a fourth head location 160d and a fifth head location 160e.

In the embodiments of FIGS. 3A and 3B, each surface 134 that is positioned unobstructed from at least one head location 160 measured during one or more observation periods is a visible surface and each surface that is positioned obstructed from each head location 160 measured during the observation period is an obstructed surface (e.g., a non-visible surface). Further, it should be understood that while a limited number of head locations 160 are depicted in FIGS. 3A and 3B, any number of head locations 160 may be measured during the observation period or during multiple observation periods.

In the example embodiment depicted in FIG. 3A, when the head 122 of the observer 120 is located in the first head location 160a, the first surface 134a is visible while the second surface 134b and the third surface 134c are obstructed. In the second head location 160b, the first surface 134a and the second surface 134b are visible and the third surface 134c is obstructed. Moreover, in the third head location 160c, the first surface 134a is visible and the second surface 134b and the third surface 134c are obstructed. Thus, in the example embodiment depicted in FIG. 3A, the first surface 134a and the second surface 134b are visible because they are each positioned unobstructed from at least one head location 160 and the third surface 134c is not visible because it is obstructed from each of the first, second, and third head locations 160a-160c. In particular, an obstruction, such as one or more additional component parts, is positioned between the third surface 134c and each of the head locations 160.

In the example embodiment depicted in FIG. 3B, when the head 122 of the observer 120 is located in the fourth head location 160d, the fourth surface 134d is visible while the fifth surface 134e and the sixth surface 134f are obstructed. Further, when the head 122 of the observer 120 is located in the fifth head location 160e, the fourth surface 134d and the fifth surface 134e are visible while the sixth surface 134f is obstructed. Thus, in the example embodiment depicted in FIG. 3B, the fourth surface 134d and the fifth surface 134e are visible because they are each positioned unobstructed from at least one head location 160 and the sixth surface 134f is not visible because it is obstructed from each of the fourth head location 160d and the fifth head location 160e.

Referring still to FIGS. 3A and 3B, the surface analysis system 100 may also determine a surface observation probability of the one or more surfaces 134 during the observation period. The surface observation probability is the probability that an individual surface 134 is visible to the observer 120 having any one individual head location 160 of the plurality of head locations 160 measured by the one or more sensors 112 during the observation period. In the example observation environment 130 depicted in FIG. 3A, the first surface 134a has a higher surface observation probability than the second surface 134b because the first surface 134a is visible from each of the first, second, and third head locations 160a-160c and the second surface 134b is visible from the first and third head locations 160a and 160c but is not visible from the second head location 160b. Thus, in this example, the first surface 134a comprises a surface observation probability of about 100% and the second surface 134b comprises a surface observation probability of about 66%.

Moreover, in the example observation environment 130 depicted in FIG. 3B, the fourth surface 134d has a higher observation probability than the fifth surface 134e because the fourth surface 134d is visible from both the fourth head location 160d and the fifth head location 160e and the fifth surface 134e is visible from the fifth head location 160e but is not visible from the fourth head location 160f. Thus, in this example, the fourth surface 134d comprises a surface observation probability of about 100% and the fifth surface 134e comprises a surface observation probability of about 50%.

In operation, the surface analysis system 100 may also determine a plurality of head location probabilities corresponding to the plurality of head locations 160 measured during the observation period. Each individual head location probability comprises a probability that the head 122 of the observer 120 is located in an individual spatial location within the observation environment 130 at a discrete observation point (e.g., moment) during the observation period based on the plurality of head locations 160 measured during the observation period. For example, each individual head location probability is the probability that at any one point during the observation period, the head 122 of the observer 120 will be located at the individual head location 160 corresponding with the individual head location probability.

Referring to FIG. 3A, as a non-limiting example, if the one or more sensors 112 measure the head 122 of the observer 120 in the first head location 160a more often than the second head location 160b, the first head location 160a would have a higher head location probability than the second head location 160b. As another non-limiting example, the head location probability may be determined by first determining an average head location of the head 122 of the observer 120 during the observation period and then measuring the distance between the average head location of the head 122 of the observer 120 between both the first head location 160a and the second head location 160b. If the average head location is closer to the first head location 160a than the second head location 160b, than the first head location probability is greater than the second head location probability.

Referring now to FIGS. 4A and 4B, the surface analysis system 100 may also generate a head location probability cloud 180 based on the plurality of head locations 160 measured during the observation period. The head location probability cloud 180 corresponds with the plurality of head location probabilities of the head 122 of the observer 120 and is a visual depiction of the head location probability. In particular, the head location probability cloud 180 is a visual depiction of the probability that the head 122 of the observer 120 will be positioned in a specific head location 160 at a discrete observation point (e.g., moment) during the observation period. The head location probability cloud 180 depicted in FIGS. 4A and 4B includes a high density region 182, an intermediate density region 184, and a low density region 186. In some embodiments, the head location probability cloud 180 may be displayed on the display 108.

The high density region 182 corresponds with locations within the observation environment 130 in which the head 122 of the observer 120 is most frequently measured during one or more observation periods. For example, when the observation environment 130 is the vehicle 150 and the observer 120 is the driver 121 of the vehicle 150 (FIG. 2), the high density region 182 may be a region between the steering wheel 152 of the vehicle 150 and the headrest 156 of a seat 154 of the vehicle 150 (FIG. 2). Further, the low density region 186 corresponds with locations within the observation environment 130 in which the head 122 of the observer 120 is least frequently measured during the one or more observation periods. For example, when the observation environment 130 is the vehicle 150 and the observer 120 is the driver 121 of the vehicle 150, the low density region 186 may comprise a region below the steering wheel 152 (FIG. 2). The intermediate density region 184 corresponds with locations within the observation environment 130 in which the head 122 of the observer 120 is more often located than in the low density region 186 and less often located than in the high density region 182. Further, regions of the observation environment 130 that are not within the head location probability cloud 180 correspond with regions within the observation environment 130 where the head 122 is not located during the one or more observation periods.

Referring now to FIGS. 5A-5B, the surface analysis system 100 may also generate a plurality of visibility polygons 190 corresponding with the one or more head locations 160 of the head 122 of the observer 120 measured during the observation period. An individual visibility polygon 190 corresponds with an individual head location 160 and includes a visible region 192 (shaded in FIGS. 5A and 5B) and an obstructed region 194 (not shaded in FIGS. 5A and 5B). Surfaces 134 within the visible region 192 are visible surfaces and surfaces 134 within the obstructed region 194 are obstructed surfaces. In operation, the surface analysis system 100 may use the plurality of visibility polygons 190 to identify which surfaces 134 are visible and which surfaces 134 are obstructed. Further, the surface analysis system 100 may determine the surface observation probability of each of the one or more surfaces 134 using the plurality of visibility polygons 190. In some embodiments, the plurality of visibility polygons 190 may be displayed on the display 108.

FIG. 5A depicts a first visibility polygon 190′ of an individual head location 160′ within the observation environment 130 depicted in FIGS. 3A and 4A. The first visibility polygon 190′ extends outward from the individual head location 160′ and includes a first visible region 192′ and a first obstructed region 194′. In the example shown in FIG. 5A, the first visibility polygon 190′ shows that from the individual head location 160′, the first surface 134a and the third surface 134c are visible, while the second surface 134b is obstructed. FIG. 5B depicts a second visibility polygon 190″ of an individual head location 160″ within the observation environment 130 depicted in FIGS. 3B and 4B. The second visibility polygon 190″ extends outward from the individual head location 160″ and includes a second visible region 192″ and a second obstructed region 194″. In this non-limiting example, the second visibility polygon 190″ shows that from the individual head location 160″, the fourth surface 134d is visible, while the fifth surface 134e and the sixth surface 134f are obstructed.

Referring now to FIGS. 6A and 6B, the surface analysis system 100 may generate a surface observation probability map 170 of the one or more surfaces 134 located in the observation environment 130, for example, one or more surfaces 134 of the vehicle 150. The surface observation probability map 170 provides a visual depiction of the surface observation probability and each surface 134 depicted in the surface observation probability map 170. Further, the surface observation probability map 170 depicts the probability that each surface 134 will be visible from a specific head location 160 at a discrete observation point (e.g., moment) during the observation period. The surface observation probability map 170 is based on the surface observation probability of each surface 134, and may additionally be based on the head location probability cloud 180 and the plurality of visibility polygons 190. In some embodiments, the surface observation probability map may be displayed on the display 108.

The surface observation probability map 170 depicted in FIGS. 6A and 6B includes a high observation probability region 172, an intermediate observation probability region 174, and a low observation probability region 176. The high observation probability region 172 corresponds with surfaces 134 of the component parts 132 which are most frequently visible during the one or more observation periods. In the non-limiting example depicted in FIGS. 6A and 6B, the first surface 134a (FIG. 6A) and the fourth surface 134d (FIG. 6B) are high observation probability regions 172. As another non-limiting example, when the component parts 132 are parts of the vehicle 150 and the observer 120 is the driver 121 of the vehicle 150 (FIG. 2), the steering wheel 152 of the vehicle 150 (FIG. 2) may comprise an example high observation probability region 172.

The low observation probability region 176 corresponds with surfaces 134 of the component parts 132 which are least frequently visible during the one or more observation periods. In the non-limiting example depicted in FIGS. 6A and 6B, the sixth surface 134f (FIG. 6B) is a low observation probability region 176. As another non-limiting example, when the component parts 132 are parts of the vehicle 150 and the observer 120 is the driver 121 of the vehicle 150 (FIG. 2), surfaces below the seat 154 may comprise example low observation probability regions 176. The intermediate observation probability region 174 corresponds with surfaces 134 of the component parts 132 which are more often visible during the one or more observation periods than the surfaces 134 corresponding with the low observation probability region 176 and less often visible during the one or more observation periods than the surfaces 134 corresponding with the high observation probability region 172. In the non-limiting example depicted in FIGS. 6A and 6B, the second surface 134b (FIG. 6A), the third surface 134c (FIG. 6A), and the fifth surface 134e (FIG. 6B) are intermediate observation probability regions 174. As another non-limiting example, when the component parts 132 are parts of the vehicle 150 and the observer 120 is the driver 121 of the vehicle 150 (FIG. 2), the central storage console 155 of the vehicle 150 (FIG. 2) may comprise an example intermediate observation probability region 174.

Moreover, in some embodiments, the high observation probability region 172, the intermediate observation probability region 174, and the low observation probability region 176 may each correspond with a percentage range of observation probabilities. As one non-limiting example, the high observation probability region 172 corresponds with an observation probability of from about 67% to about 100%, the intermediate observation probability region 174 corresponds with an observation probability of from about 34% to about 66%, and the low observation probability region 176 corresponds with an observation probability of from about 0% to about 33%.

Referring still to FIGS. 6A and 6B, in some embodiments, the surface observation probability map 170 comprises a color map such that the high observation probability region 172, the intermediate observation probability region 174, and the low observation probability region 176 may each be represented by a different color in the surface observation probability map 170. For example the high observation probability region 172 may be red, the intermediate observation probability region 174 may be yellow, and the low observation probability region 176 may be blue. Further, in some embodiments, the surface observation probability map 170 may depict a visual gradient of colors or other visual indicators (e.g., patterns, shadings, or the like) which correspond with the surface observation probability of each surface 134.

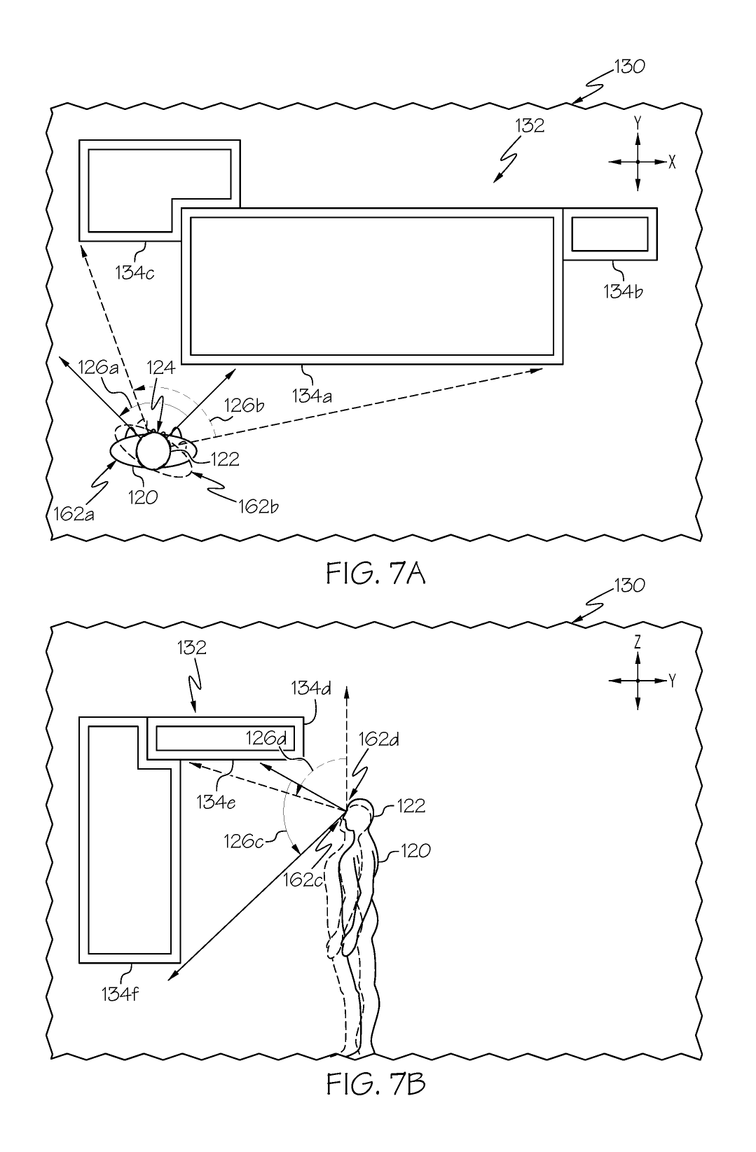

Referring now to FIGS. 7A and 7B, in some embodiments, the head orientation 162 of the observer 120 may be monitored by the one or more sensors 112. The head orientation 162 of the observer 120 corresponds with a field of view 126 extending outward from the face 124 of the observer 120, for example, extending in the pointing direction of the face 124 of the observer 120. Further, the field of view 126 corresponds with a region within the observation environment 130 that is visible to the observer 120 having the individual head orientation 162. While not intending to be limited by theory, the field of view 126 of the observer 120 (e.g., the field of view of an average human) may extend horizontally (e.g., in the X-Y plane of FIG. 7A) about 120° and may extend vertically (e.g., in the Y-Z plane of FIG. 7B) about 120°. In operation, the surfaces 134 that are within the field of view 126 of the observer 120 corresponding with at least one head orientation 162 measured during one or more observation periods are visible surfaces and the surfaces 134 that are not within the field of view 126 corresponding with any head orientation 162 measured during one or more observation periods are obstructed surfaces, e.g., not visible surfaces.

FIG. 7A schematically depicts a top view of the observer 120 and the plurality of component parts 132 each comprising at least one surface 134 positioned in the observation environment 130 of FIGS. 3A, 4A, 5A, and 6A. FIG. 7A depicts multiple head orientations 162 of the observer 120 along the X-Y plane, for example, a first head orientation 162a and a second head orientation 162b. FIG. 7B schematically depicts a side view of the observer 120 and the plurality of component parts 132 each comprising at least one surface 134. Further, FIG. 7B depicts multiple head orientations along the Y-Z plane, for example, a third head orientation 162c and a fourth head orientation 162d.

In the example embodiment depicted in FIG. 7A, when the head 122 of the observer 120 is in the first head orientation 162a, a first field of view 126a extends outward from the face 124 of the observer 120 and when the head 122 of the observer 120 is in the second head orientation 162b, a second field of view 126b extends outward from the face 124 of the observer 120. As depicted in FIG. 7A, in both the first head orientation 162a and the second head orientation 162b, both the first surface 134a and the third surface 134c are visible and the second surface 134b is obstructed. Further, a larger portion of the first surface 134a is visible in the second head orientation 162b than is visible in the first head orientation 162a.

In the example embodiment depicted in FIG. 7B, when the head 122 of the observer 120 is in the third head orientation 162c, a third field of view 126c extends outward from the face 124 of the observer 120 and when the head 122 of the observer 120 is in the fourth head orientation 162d, a fourth field of view 126d extends outward from the face 124 of the observer 120. As depicted in FIG. 7B, in the third head orientation 162c, the fifth surface 134e is visible, while the fourth surface 134d and the sixth surface 134f are each obstructed. Further, in the fourth head orientation 162d, the fourth surface 134d and the fifth surface 134e are both visible, while the sixth surface 134f is obstructed. Further, a larger portion of the fifth surface 134e is visible in the fourth head orientation 162d than in the third head orientation 162c.

In some embodiments, the surface analysis system 100 may determine the surface observation probability of at least one of the one or more surfaces 134 based on the one or more head orientations 162 measured during the one or more observation periods. In this embodiment, the surface observation probability is a probability that an individual surface 134 is visible to the observer 120 having any one individual head orientation 162 of the plurality of head orientations 162. The surface observation probability determined in this embodiment may also be used to generate a surface observation probability map 170 of the one or more surfaces 134 located in the observation environment 130, as described above.

Further, the surface analysis system 100 may determine a plurality of head orientation probabilities, each comprising a probability that the head of the observer is in an individual head orientation 162 at a discrete observation point during the observation period based on the plurality of head orientations 162 measured during the observation period. Moreover, in some embodiments, the surface analysis system 100 may generate one or more visibility polygons 190, similar to the visibility polygons 190 depicted in FIGS. 5A and 5B, which correspond with one or more head orientations 162. In this embodiment, the visible region 192 of the visibility polygon 190 comprises the regions within the observation environment 130 that are within the field of view 126 of the observer 120 and the obstructed region 194 of the visibility polygon 190 comprises the regions within the observation environment 130 that are outside of the field of view 126 of the observer 120.

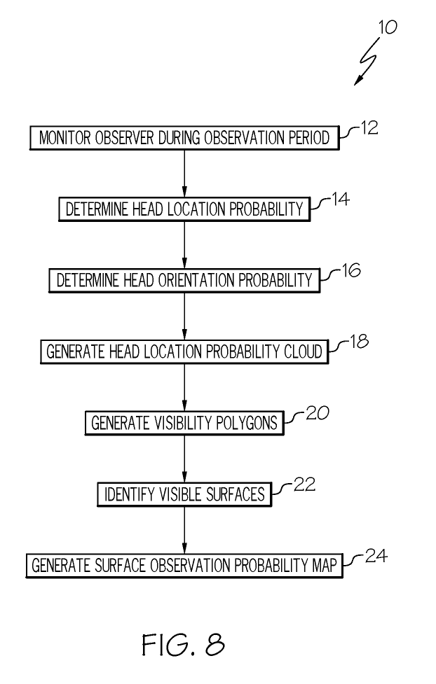

Referring now to FIG. 8, a flow chart 10 depicting a method for identifying one or more visible surfaces in the observation environment 130 is illustrated. The flow chart 10 depicts a number of method steps illustrated by boxes 12-24. While the method is described in a particular order, it should be understood that other orders are contemplated. First, at box 12, the method comprises monitoring the observer 120 located within the observation environment 130 during the one or more observation periods, for example, using the one or more sensors 112. Monitoring the observer 120 may comprise measuring, using the one or more sensors 112, a plurality of head locations 160 (FIGS. 3A and 3B) of the head 122 of the observer 120 during the one or more observation periods. Further, in some embodiments, monitoring the observer 120 may comprise measuring, using the one or more sensors 112, a plurality of head orientations 162 (FIGS. 7A and 7B) of the head 122 of the observer 120 positioned within the observation environment 130 during the one or more observation periods.

Next, at box 14, the method may include determining a plurality of head location probabilities based on the plurality of head locations 160 observed during the observation period. As stated above, each individual head location probability comprises a probability that the head 122 of the observer 120 is in an individual location within the observation environment 130 at a discrete observation point during one or more observation periods. In some embodiments, at box 16, the method further includes determining a plurality of head orientation probabilities based on the plurality of head orientations observed during the observation period. As stated above, each individual head orientation probability comprises a probability that the head of the observer is in an individual head orientation 162 at a discrete observation point during the observation period. Further, at box 18, the method may include generating the head location probability cloud 180 (FIGS. 4A and 4B) based on the plurality of head locations 160 measured during the observation period and corresponding with the plurality of head location probabilities of the head 122 of the observer 120. Moreover, at box 20, the method may include generating the one or more visibility polygons 190 (FIGS. 5A and 5B) corresponding with the one or more head locations 160 of the head 122 of the observer 120 measured during the observation period.

Referring still to FIG. 8, at box 22, the method may next include identifying one or more visible surfaces of the one or more surfaces 134 positioned in the observation environment 130 based on one or both of the plurality of head locations 160 measured during the one or more observation periods and the plurality of head orientations 162 measured during the one or more observation periods. In some embodiments, the one or more visible surfaces may comprise the one or more surfaces 134 positioned unobstructed from at least one head location 160 of the observer 120 measured during the one or more observation periods (e.g., when the visible surfaces are identified using the plurality of head locations 160). Further, in some embodiments, the one or more visible surfaces may comprise the one or more surfaces 134 positioned within a field of view 126 corresponding with at least one head orientation 162 of the observer measured during the observation period (e.g., when the visible surfaces using the plurality of head orientations 162). Moreover, at box 24, the method may include generating the surface observation probability map 170 based on the surface observation probability of each surface 134, and in some embodiments, based on the head location probability cloud 180 and the plurality of visibility polygons 190.

It should be understood that embodiments described herein provide for surface analysis systems for identifying visible surfaces of parts positioned in an observation environment, such as visible surfaces of parts of a vehicle, and in some embodiments, determining the surface observation probability of each of the surfaces positioned in the observation environment. The surface analysis system may measure a plurality of head locations and/or head orientations of the observer during one or more observation periods using one or more sensors. Further, the surface analysis system may identify the one or more visible surface by determining which surfaces are positioned unobstructed from at least one head location and/or positioned within a field of view of at least one head orientation of the observer. The one or more sensors may be image sensors, proximity sensors, and/or motion capture sensors and may interact with one or more motion trackers located on the observer to determine the head location of the head of the observer. The surface analysis system may also generate head location probability clouds and visibility polygons corresponding with one or more head locations to help identify the visible surfaces of the parts positioned in the observation environment. Identifying visible surfaces and surface observation probabilities may help improve the design, manufacture, and assembly of vehicles or other products having visible surfaces.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A surface analysis system comprising:
a sensor for generating data regarding a location of an object;
one or more processors communicatively coupled to the sensor;
one or more memory modules communicatively coupled to the one or more processors; and
machine readable instructions stored in the one or more memory modules that cause the surface analysis system to perform at least the following when executed by the one or more processors:
measure a plurality of head locations of a head of an observer within an observation environment during an observation period using the sensor, wherein one or more surfaces are positioned in the observation environment; and
identify one or more visible surfaces of the one or more surfaces positioned in the observation environment based on the plurality of head locations measured during the observation period, wherein:
the one or more visible surfaces comprise at least one of the one or more surfaces positioned in the observation environment; and
the one or more visible surfaces are positioned unobstructed from at least one head location of the observer measured during the observation period.

2. The surface analysis system of claim 1, wherein the machine readable instructions stored in the one or more memory modules further cause the surface analysis system to perform at least the following when executed by the one or more processors:
determine a surface observation probability of at least one of the one or more surfaces during the observation period, wherein the surface observation probability comprises a probability that an individual surface is visible to the observer having an individual head location of the plurality of head locations.

3. The surface analysis system of claim 2, wherein the machine readable instructions stored in the one or more memory modules further cause the surface analysis system to perform at least the following when executed by the one or more processors:
generate a surface observation probability map of the one or more surfaces positioned in the observation environment, wherein the surface observation probability map depicts the surface observation probability of the one or more surfaces.

4. The surface analysis system of claim 1, wherein the machine readable instructions stored in the one or more memory modules further cause the surface analysis system to perform at least the following when executed by the one or more processors:
determine a plurality of head location probabilities, wherein each individual head location probability comprises a probability that the head of the observer is in an individual location within the observation environment at a discrete observation point during the observation period based on the plurality of head locations observed during the observation period.

5. The surface analysis system of claim 4, wherein the machine readable instructions stored in the one or more memory modules further cause the surface analysis system to perform at least the following when executed by the one or more processors:
generate a head location probability cloud based on the plurality of head locations and the plurality of head location probabilities.

6. The surface analysis system of claim 1, wherein the machine readable instructions stored in the one or more memory modules further cause the surface analysis system to perform at least the following when executed by the one or more processors:
generate a plurality of visibility polygons, wherein each individual visibility polygon corresponds to an individual head location and each individual visibility polygon depicts one or more surfaces positioned unobstructed from the individual head location; and
identify the one or more visible surfaces using the plurality of visibility polygons.

7. The surface analysis system of claim 1, wherein:
a vehicle is positioned within the observation environment;
the one or more surfaces comprise a plurality of vehicle part surfaces of one or more vehicle parts; and
the observer is positioned within the vehicle during the observation period.

8. The surface analysis system of claim 1, wherein the at least one sensor comprises an image sensor, a motion capture sensor, a proximity detector, or combinations thereof.

9. The surface analysis system of claim 1, wherein the at least one sensor is coupled to a wearable device configured to be worn by the observer.

10. The surface analysis system of claim 1, further comprising one or more tracking markers configured to be worn by the observer.

11. A method of identifying one or more visible surfaces in an observation environment, the method comprising:
measuring, using a sensor configured to generate data regarding a location of an object, a plurality of head locations of a head of an observer within an observation environment during an observation period, wherein one or more surfaces are positioned in the observation environment;
identifying one or more visible surfaces of the one or more surfaces positioned in the observation environment based on the plurality of head locations measured during the observation period, wherein:
the one or more visible surfaces comprise at least one of the one or more surfaces positioned in the observation environment; and
the one or more visible surfaces are positioned unobstructed from at least one head location of the observer measured during the observation period.

12. The method of claim 11, further comprising determining a plurality of head location probabilities, wherein each individual head location probability comprises a probability that the head of the observer is in an individual location within the observation environment at a discrete observation point during the observation period based on the plurality of head locations observed during the observation period.

13. The method of claim 12, further comprising generating a head location probability cloud based on the plurality of head locations and the plurality of head location probabilities.

14. The method of claim 11, further comprising measuring, using the sensor, a plurality of head orientations of the head of the observer positioned within the observation environment during the observation period, wherein each head orientation of the plurality of head orientations corresponds with a field of view extending from a face of the observer into the observation environment.

15. The method of claim 14, further comprising determining a plurality of head orientation probabilities using one or more processors communicatively coupled to the sensor, wherein each individual head orientation probability comprises a probability that the head of the observer is in an individual head orientation at a discrete observation point during the observation period based on the plurality of head orientations observed during the observation period.

16. The method of claim 14, further comprising identifying one or more visible surfaces of the one or more surfaces positioned in the observation environment based on the plurality of head orientations measured during the observation period, wherein:
the one or more visible surfaces are positioned unobstructed from at least one head location of the observer measured during the observation period; and
the one or more visible surfaces are within a field of view corresponding with at least one head orientation of the observer measured during the observation period.

17. A surface analysis system comprising:
a sensor for generating data regarding an orientation of an object;
one or more processors communicatively coupled to the sensor;
one or more memory modules communicatively coupled to the one or more processors; and
machine readable instructions stored in the one or more memory modules that cause the surface analysis system to perform at least the following when executed by the one or more processors:
measure a plurality of head orientations of a head of an observer within an observation environment during an observation period using the sensor, wherein:
each head orientation of the plurality of head orientations corresponds with a field of view extending from the head of the observer into the observation environment; and
one or more surfaces are positioned in the observation environment;
identify one or more visible surfaces of the one or more surfaces positioned in the observation environment based on the plurality of head orientation measured during the observation period, wherein:
the one or more visible surfaces comprise at least one of the one or more surfaces positioned in the observation environment; and
the one or more visible surfaces are within a field of view corresponding with at least one head orientation of the observer measured during the observation period.

18. The surface analysis system of claim 17, wherein the machine readable instructions stored in the one or more memory modules further cause the surface analysis system to perform at least the following when executed by the one or more processors:
determine a surface observation probability of at least one of the one or more surfaces during the observation period, wherein the surface observation probability comprises a probability that an individual surface is visible to the observer having an individual head orientation of the plurality of head orientations.

19. The surface analysis system of claim 17, wherein the machine readable instructions stored in the one or more memory modules further cause the surface analysis system to perform at least the following when executed by the one or more processors:
determine a plurality of head orientation probabilities, wherein each individual head orientation probability comprises a probability that the head of the observer is in an individual head orientation at a discrete observation point during the observation period based on the plurality of head orientations observed during the observation period.

20. The surface analysis system of claim 17, wherein:
a vehicle is positioned within the observation environment;
the one or more surfaces comprise a plurality of vehicle part surfaces of one or more vehicle parts; and
the observer is positioned within the vehicle during the observation period.
